(19) United States
(12) Patent Application Publication
(10) Pub. No.: US 2026/0141769 A1
(43) Pub. Date: May 21, 2026

(54) BACCARAT GAME SYSTEM CAPABLE OF SCREENING GAMES AND GAME SCREENING METHOD THEREOF

(71) Applicant: JUMBO TECHNOLOGY CO., LTD., TAICHUNG (TW)

(72) Inventors: Shun Tsung HSU, TAICHUNG (TW); Chang Yi WANG, TAICHUNG (TW); Yen Wei CHANG, TAICHUNG (TW)

(21) Appl. No.: 19/113,828

(22) PCT Filed: Sep. 23, 2022
(86) PCT No.: PCT/CN2022/120964

§ 371 Date: Mar. 20, 2025

(51) Int. Cl. G07F 17/32

(52) U.S. Cl. CPC G07F 17/3211; G07F 17/3209; G07F 17/3232; G07F 17/3244; G07F 17/3288; G07F 17/3293

(57) ABSTRACT

The present invention relates to a baccarat game system capable of screening games and a game screening method thereof. After at least one player respectively selects any one of at least one screening rule by means of a screening selection button, a screening device screens out a baccarat game meeting the screening rule, and a display element corresponding to the at least one player displays a historical game record of the baccarat game meeting the screening rule; after the at least one player places a bet on the selected baccarat game by means of a plurality of betting buttons and a new game result is generated, a payment processing unit pays for the at least one player. In this way, the at least one player can be assisted to place a bet, so that the betting efficiency is improved, thereby improving the billing.

### FIELD OF THE INVENTION

The present invention relates to a game system, in particular to a baccarat game system for filtering game and a game filtering method thereof.

### BACKGROUND OF THE INVENTION

As shown in FIG. 1, a plurality of man-machine operation interfaces 1 can be connected to a plurality of game consoles 2; and a player can bet directly by operating the man-machine operation interface 1 to select the game console 2 to be played. The method can break through the limitation of a space environment; and the player can bet on the game consoles 2 at the same time, thereby improving utilization efficiency of the game consoles 2.

In addition, each game console 2 is generally provided with a corresponding game history board 3; and each game history board 3 can display historical game results of each game console 2. Therefore, the player can know the historical game results of the different game consoles 2 by switching and browsing different game history boards 3 through the man-machine operation interface 1, and choose the desired game console 2 to bet, so as to satisfy betting preferences of the player.

Generally, the player has a habit of following up and betting on popular games. The so-called popular games refer to the fact that the historical game results of the game consoles 2 meet certain conditions, causing the player to follow up and bet. For example, taking baccarat as an example, when the number of continuous winning times of Banker or Player exceeds a certain number, it can be called a popular game of Dragon; and different people or different regions have different definitions of “Dragon”. It can be called “Dragon” if the number of continuous winning times of a Banker or Player is more than 2˜5 times. During calculation of the number of continuous winning times: for example, when the historical game results are “Banker→Tie→Banker” in sequence, it is not Dragon if “Tie” is calculated; and it is Dragon if “Tie” is not calculated. Both calculation methods are adopted. Or, there may be a regular result: for example, when a Banker and a Player appear at an interval for at least twice, it is called Ping Pong; it is called Double Ping Pong when two Bankers and two Players appear at an interval for at least twice; and it is called One Two when one Banker (or Player) and two Players (or Bankers) appear at an interval for at least twice. At this time, the player will generally follow up and bet until the regular ending of the game result. In the popular game of Dragon, the player can bet on Dragon; and betting on Dragon is the bet on that the Banker or Player keeps winning continuously. Or the player can bet on Behead, which means the bet on that the Banker or Player stops winning continuously.

However, when the player uses the man-machine operation interface 1 to play a game, except the running game console 2, the player cannot know whether other game consoles 2 available for the player to play the game have generated popular games. Hence, the player often has to browse different game history boards 3 in order not to miss the popular games, which consumes a lot of vigor of the player, causes the player to feel tired soon, obviously reduces the actual playing time of the player, and thus reduces the utilization rate of the game consoles 2.

### SUMMARY OF THE INVENTION

A main purpose of the present invention is to provide a baccarat game system for filtering game and a game filtering method thereof.

In order to achieve the above purpose, the present invention provides a baccarat game system for filtering game and a game filtering method thereof, provided for at least one player to play. In an embodiment, the baccarat game system comprises: a game result generating unit, a filter, at least one player unit, a payout processing unit and a game processing unit. The game result generating unit executes a plurality of baccarat games, wherein each of the plurality of baccarat games independently executes and continuously generates one of a plurality of game results, each of the plurality of baccarat games includes an identification symbol and a game picture, and each of the plurality of baccarat games includes a historical game record constituted of the plurality of game results generated. The filter screens out historical game records of the plurality of baccarat games according to a filtering rule selected from at least one filtering rule, so as to filter out baccarat games conforming to the filtering rule. Each player unit comprises an operation interface and a display assembly, wherein the operation interface is operated by the at least one player for playing, and the display assembly provides game information to the at least one player. The payout processing unit pays out to the at least one player. The game processing unit connects to the game result generating unit, the filter, the at least one player unit and the payout processing unit, wherein the game processing unit performs the following steps S1-S4:
Step S1: commanding the game result generating unit to execute the plurality of baccarat games;
Step S2: commanding the filter to filter out the baccarat games conforming to the filtering rule after the at least one player selecting the filtering rule from at least one filtering rule by the at least one player through the operation interface;
Step S3: commanding the display assembly to display the historical game records of the baccarat games conforming to the filtering rule to the at least one player; and
Step S4: commanding the payout processing unit to pay out to the at least one player according to the game result after the at least one player betting on a baccarat game selected through the operation interface and a new game result of the baccarat game is generated.

In another embodiment, the operation interface further comprises at least one filtering selection button, at least one symbol selection button and a plurality of betting buttons. The at least one filtering selection button corresponds to at least one of the filtering rule, the at least one symbol selection button corresponds to different identification symbols, and the plurality of betting buttons are used to bet on the plurality of game results.

When the game processing unit performs steps S1-S4, in step S2, after the player selects one of the at least one filtering rule through the at least one filtering selection button, the filter is commanded to filter out the baccarat game conforming to the filtering rule. In step S3, the display assembly corresponding to the player displays the identification symbol of the baccarat game conforming to the filtering rule, and after the player selects the specific identification symbol through the at least one symbol selection button, the display assembly is commanded to display the historical game record of the corresponding baccarat game. In step S4, the player bets on the selected baccarat game through the plurality of betting buttons.

Further, according to the baccarat game system used in the game filtering method of the present invention, as mentioned above, the game filtering method comprises the following steps performed by the game processing unit:
commanding the game result generating unit to execute a plurality of baccarat games, wherein each of the plurality of baccarat games independently executes and continuously generates one of a plurality of game results, each of the plurality of baccarat games includes an identification symbol and a game picture, and each of the plurality of baccarat games includes a historical game record constituted of the plurality of game results generated;
commanding the filter to filter out historical game records of the plurality of baccarat games according a filtering rule selected from at least one filtering rule by the at least one player through the operation interface, so as to filter out the baccarat games conforming to the filtering rule;
commanding the display assembly to display the historical game record of the baccarat games conforming to the filtering rule to the at least one player, so that the at least one player can bet on the at least one baccarat game conforming to the filtering rule; and
commanding the payout processing unit to pay out to the at least one player according to a game result after the at least one player bets through the operation interface and a new game result of the baccarat game is generated.

To sum up, the present invention can assist the at least one player in betting; and through assistance of the filter, the game picture of the baccarat game conforming to the filtering rule can be displayed on the display assembly, so that the at least one player can directly select the baccarat game conforming to the filtering rule to bet, thereby improving the betting efficiency, eliminating the time of checking the historical game records one by one, and further increasing the actual playing time of the player. Hence, the turnover can be increased.

### BRIEF DESCRIPTION OF THE DRAWINGS

FIG. 1 is a system diagram of a plurality of game consoles in the prior art.

FIG. 2 is a system diagram of a baccarat game system of the present invention.

FIG. 3A is a schematic diagram of a game picture according to a first embodiment of the present invention.

FIG. 3B is a partially enlarged schematic diagram of FIG. 3A of the present invention.

FIG. 3C is a schematic diagram of filtering selection buttons of the present invention.

FIG. 3D is a schematic diagram of one-click betting selection buttons of the present invention.

FIG. 4 is a flowchart of running of a game processing unit of the present invention.

FIG. 5 is a schematic diagram of a network server of the present invention.

FIG. 6 is a schematic diagram of a game picture according to a second embodiment of the present invention.

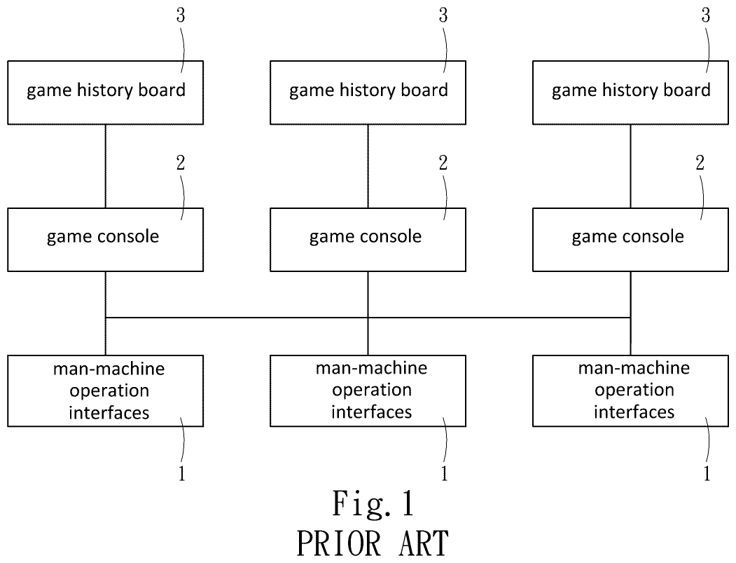

### DETAILED DESCRIPTION OF THE PREFERRED EMBODIMENTS

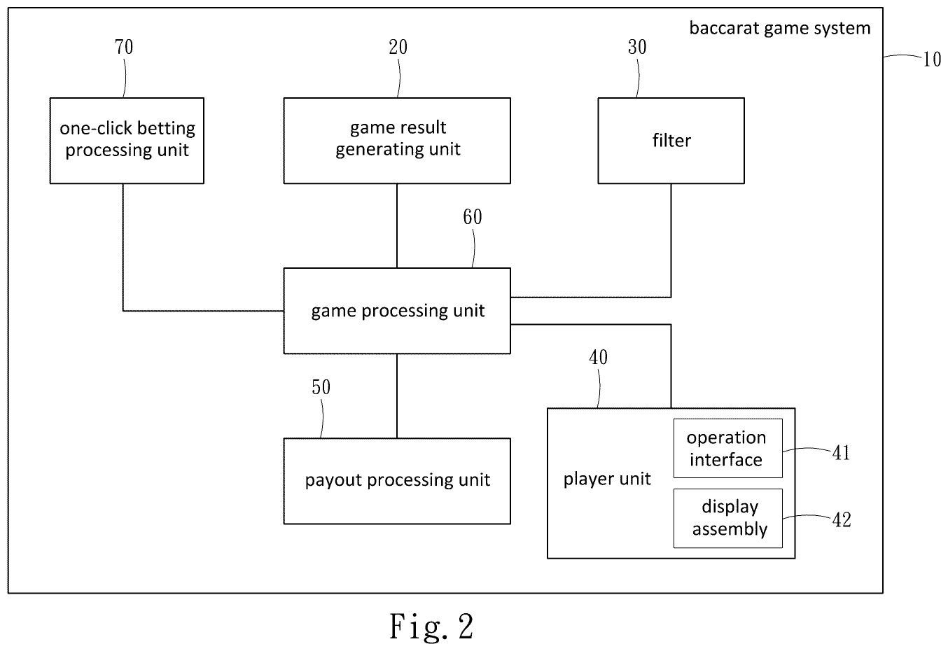

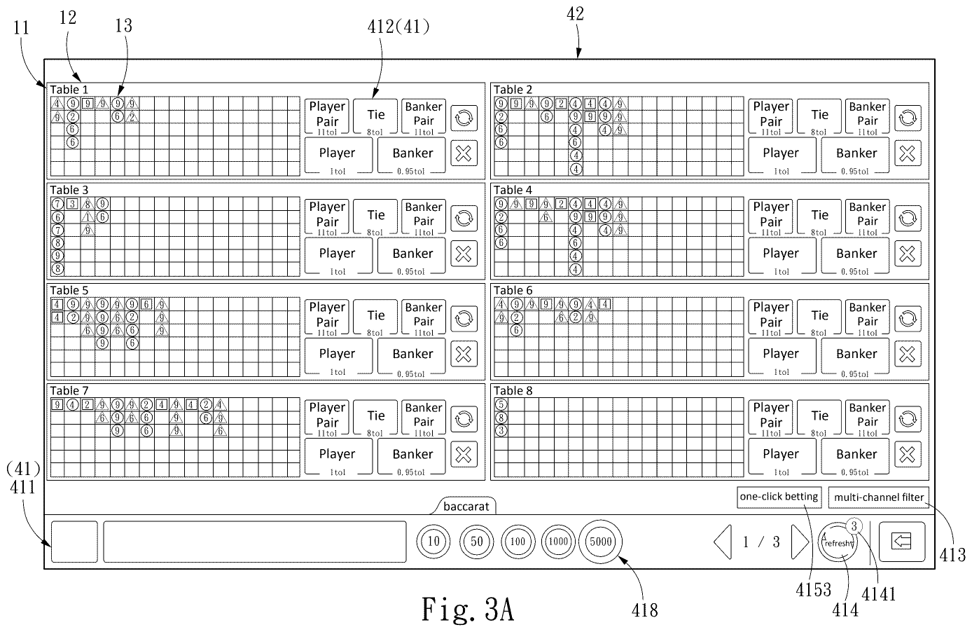

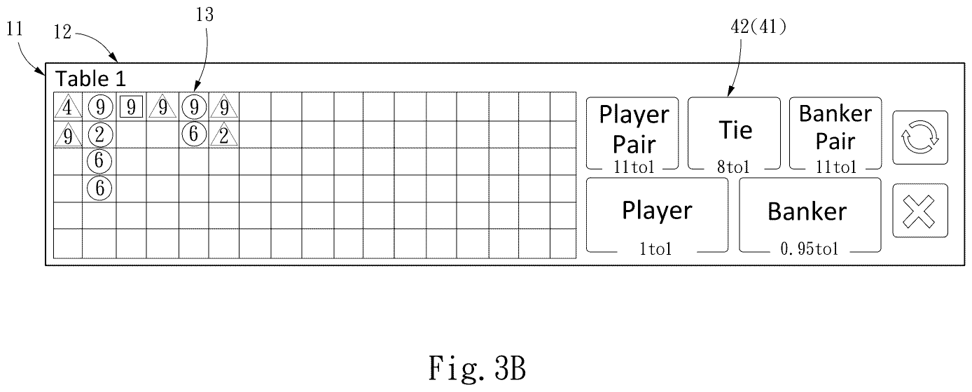

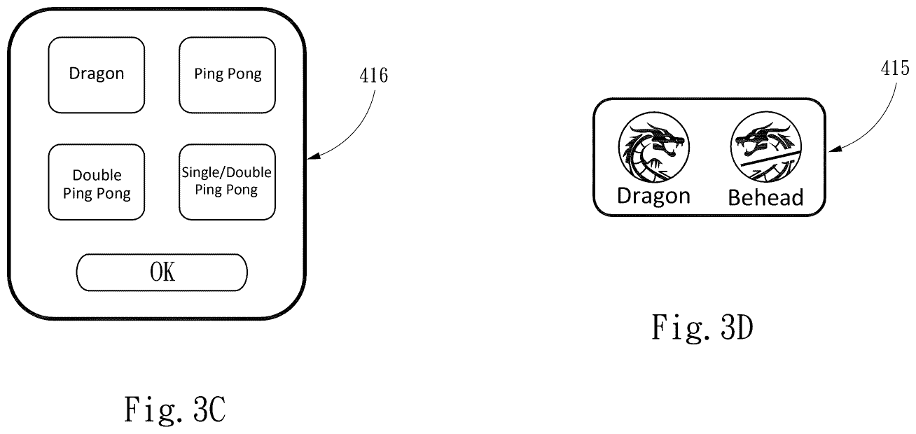

The detailed description and technical contents of the present invention are described as follows with reference to the accompanying drawings:
Referring to FIG. 2, FIG. 3A and FIG. 3B, a first embodiment of the present invention provides a baccarat game system 10 for filtering game provided for playing by at least one player. The baccarat game system 10 comprises a game result generating unit 20, a filter 30, at least one player unit 40, a payout processing unit 50 and a game processing unit 60. The game result generating unit 20 executes a plurality of baccarat games, each of the plurality of baccarat games is independently executing and continuously generates any one of a plurality of game results, and each of the plurality of baccarat games includes an identification symbol 11 and a game picture 12, and each of the plurality of baccarat games includes a historical game record 13 constituted of the plurality of game results generated. A recording mode of the plurality of game results in the historical game record 13 is not unique, but clearly indicated that the plurality of game results (Banker, Tie or Player) as shown in FIG. 3B, in which a circle indicates a game result of Banker, a triangle indicates a game result of Player, and a square indicates a game result of Tie. When a current game result is different from a previous game result, a record will be made in another row, and a middle number records a card reading of the winner or a tie game in a game result.

The filter 30 filters out historical game records 13 of the plurality of baccarat games according to a filtering rule selected from at least one filtering rule, so as to filter out baccarat games conforming to the filtering rule. Screening rules include: Dragon, Ping Pong, Double Ping Pong, Single/Double Ping Pong, etc. In order to meet business needs, at least one of the filtering rules can be generated by self-setting, that is, at least one of the filtering rules is generated by self-setting according to preferences, popularity and frequency of use of players in different regions. Further, the at least one of the filtering rules can also be generated by setting by the player so as to properly meet use requirements

Each player unit 40 comprise an operation interface 41 and a display assembly 42, wherein the operation interface 41 is operated by the player for playing; and the display assembly 42 provides game information to the player, such as the game picture 12. In an embodiment, the operation interface 41 is either a mouse or a keyboard, and the display assembly 42 is a computer screen. The mouse, the keyboard and the computer screen are all part of a personal computer (PC), that is, the player can use the PC as the operation interface 41 and operate the display assembly 42 for playing. In another embodiment, the operation interface 41 and the display assembly 42 can be combined into a touch screen, as shown in FIG. 3A. The display assembly 42 directly displays the game picture 12, and the operation interface 41 comprises various function options 411 and betting options 412 displayed on the game picture 12. As shown in FIG. 3A, the function options 411 include a plurality of betting buttons 418, and the plurality of betting buttons 418 comprise a plurality of chips. By clicking the chips selected and then clicking five betting zones, namely Banker, Player, Tie, Player Pair and Banker Pair, of the betting options 412 selected to complete betting. The touch screen is a part of a smart phone, a tablet computer; or a man-machine operation interface dedicated to games. The payout processing unit 50 makes payouts to the at least one player.

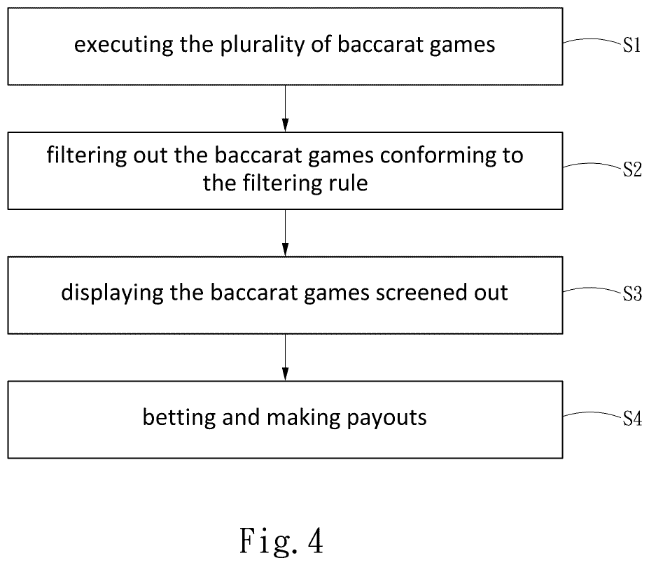

Referring to FIG. 4 together, the game processing unit 60 connects with the game result generating unit 20, the filter 30, the at least one player unit 40 and the payout processing unit 50. The game processing unit 60 performs the following steps: S1: executing the plurality of baccarat games; S2: filtering out the baccarat games conforming to the filtering rule; S3: displaying the baccarat games filtered out; and S4: betting and making payouts.

In step S1: commanding the game result generating unit 20 to execute the plurality of baccarat games.

In step S2: commanding the filter 30 to filter out the baccarat games conforming to a filtering rule which is selected from at least one filtering rule by the player through the operation interface 41. In an embodiment, the operation interface 41 comprises a multi-channel filter 413, and at least one filtering selection button 416 (as shown in FIG. 3C) appears after the multi-channel filter 413 is clicked and selected. The at least one filtering selection button 416 corresponds to at least one of the filtering rules (such as Dragon, Ping Pong, Double Ping Pong, Single/Double Ping Pong, etc.) respectively, and the player selects and clicks at least one of the filtering rules according to preferences.

In step S3: commanding the display assembly 42 to display the historical game records 13 of the baccarat games conforming to the filtering rule to the player. As shown in FIG. 3A, the historical game records 13 of the baccarat games conforming to the filtering rule are displayed in the display assembly 42 in parallel. The player can decide the baccarat games he/she wants to bet on according to historical game records 13 of different baccarat games displayed on the display assembly 42.

In an embodiment, when a new game result appears, the historical game record 13 of the one of the baccarat games will be updated in real time. Therefore, when the player has selected and clicked one of the filtering rules, it is possibly being changed that the historical game records 13 of the baccarat games conforms to the filtering rule during the time waiting for the player to consider betting. Therefore, the game processing unit 60 commands the filter 30 to filter out the baccarat games conforming to the filtering rule again at intervals of regular time, such as every one minute, and a latest historical game record 13 is displayed on the display assembly 42 to the player. In another embodiment, the operation interface 41 further comprises a filtering refresh button 414. When the filtering refresh button 414 is triggered, the filter 30 re-filters out the baccarat games conforming to the filtering rule. During implementation, the filtering refresh button 414 automatically displays a latest filtering information 4141. In an embodiment, the latest filtering information 4141 is a number which represents an increase quantity or decrease quantity of the baccarat games conforming to the filtering rule. For example, inexistence of the number represents no change in the quantity. However, as shown in FIG. 3A, the number is “3”, indicating that three baccarat games conforming to the filtering rule are added.

In step S4: commanding the payout processing unit 50 to pay out to the player according to the game result in which the player betting on a baccarat game selected through the operation interface 41 to generate thereof. A manner in which the player bets on the baccarat game selected through the operation interface 41 would be slightly different depending on implementations of the operation interface 41 and the display assembly 42. For example, if the operation interface 41 is either the mouse or the keyboard, and the display assembly 42 is the computer screen, the player plays a game by operating a personal computer (PC), and the player controls a cursor on the computer screen by using the mouse or the keyboard to select and click an option of betting. If the operation interface 41 and the display assembly 42 refer to the touch screen, as shown in FIG. 3A, the betting option 412 is selected and clicked on the touch screen for betting directly.

Further, referring to FIG. 2, FIG. 3A and FIG. 3D together, in one embodiment, the present invention further comprises a one-click betting processing unit 70 which is linked to the game processing unit 60, the one-click betting processing unit 70 executes at least one betting rule. The operation interface 41 comprises at least one one-click betting selection button 415, the at least one one-click betting selection button 415 corresponds to the at least one betting rule. When the filter 30 filters out the baccarat games conforming to the filtering rule, if the player selects and clicks the at least one one-click betting selection button 415, the game processing unit 60 makes the one-click betting processing unit 70 directly execute the at least one betting rule corresponded, so as to bet on the baccarat games conforming to the filtering rule. In order to avoid identification confusion for the player because of too much information displayed by the display assembly 42, a button shown as a one-click betting 4153 is displayed first, and when the one-click betting 4153 is selected and clicked, the one-click betting 4153 will expand to show the at least one one-click betting selection button 415. In an embodiment, Dragon and Behead are shown in the at least one one-click betting selection button 415, as shown in FIG. 3D. Further, when there are not many numbers of selection in the at least one one-click betting selection button 415, for example, the selection only includes Dragon and Behead, Dragon and Behead in the at least one one-click betting selection button 415 as shown in FIG. 3D can also be permanently displayed on the display assembly 42 to increase the convenience of operations.

When the player selects and clicks Dragon in the at least one one-click betting selection button 415, the one-click betting processing unit 70 will directly execute: betting “Dragon” on the baccarat game of Dragon. Similarly, when the player selects and clicks Behead in the at least one one-click betting selection button 415, the one-click betting processing unit 70 will directly execute: betting “Behead” on the baccarat game of Dragon. If the baccarat game has been changed from Dragon to Behead upon the player betting on the baccarat game of Dragon, the one-click betting processing unit 70 will not execute betting.

Further, in order to make the player know a betting execution situation of the one-click betting processing unit 70, the one-click betting processing unit 70 generates a display program during betting, and the display program displays information of actual betting by the one-click betting processing unit 70 on the display assembly 42. In an embodiment, the information of actual betting is to display the total number and the total bet amount of the baccarat games that have been bet, so that the player can clearly know an overall situation of current betting.

In addition, a bet amount of betting made by the one-click betting processing unit 70 on the baccarat games conforming to the filtering rule may be a certain value, that is, the player can set a number of the certain value by herself/himself, and the number of the certain value will be bet by the one-click betting processing unit 70 upon betting. In addition, in order to facilitate the player to control a total bet amount, a sum of bets made by the one-click betting processing unit 70 on the baccarat games conforming to the filtering rule may be the total bet amount which is also a certain value, and the bet amount of the baccarat games conforming to the filtering rule is obtained by equally dividing the total bet amount, that is, the more the baccarat games conform to the filtering rule, the less the bet amount each will be. Except for equally dividing the total bet amount, the bet amount of the baccarat games conforming to the filtering rule may also be allocated according to numbers of consecutive times conforming to the filtering rule. In other words, the more the consecutive times conform to the filtering rule, the more values to be allocated there will be. For example, when the filtering rule is Dragon, the more the consecutive times conform to the filtering rule, the longer the length of Dragon will be, and a large share ratio can be obtained.

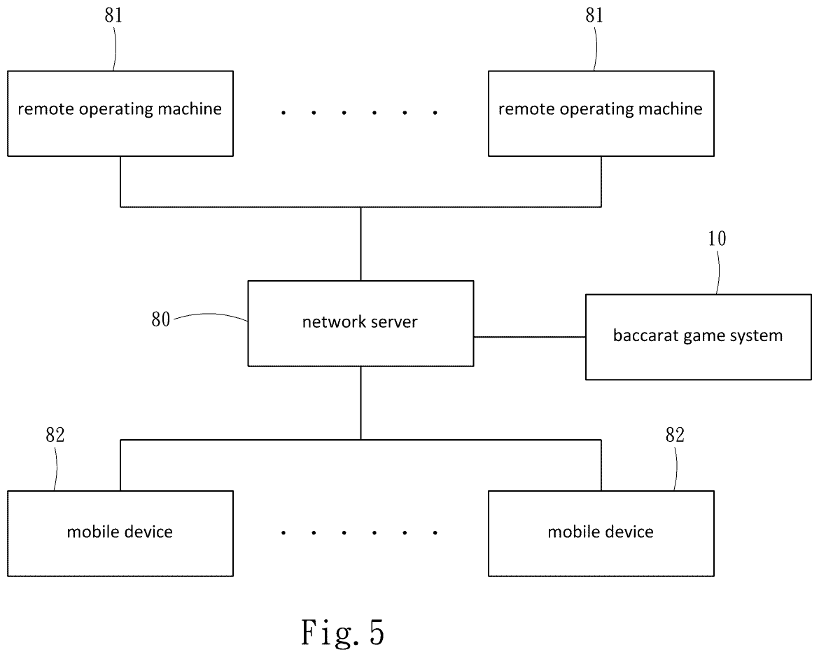

Referring to FIG. 5 together, in order to satisfy needs of providing remote services, the baccarat game system 10 is connected to a network server 80. The network server 80 is connected to a plurality of remote operating machines 81 and a plurality of mobile devices 82, and the plurality of remote operating machines 81 and the plurality of mobile devices 82 are respectively used as the at least one player unit 40 for the at least one player using.

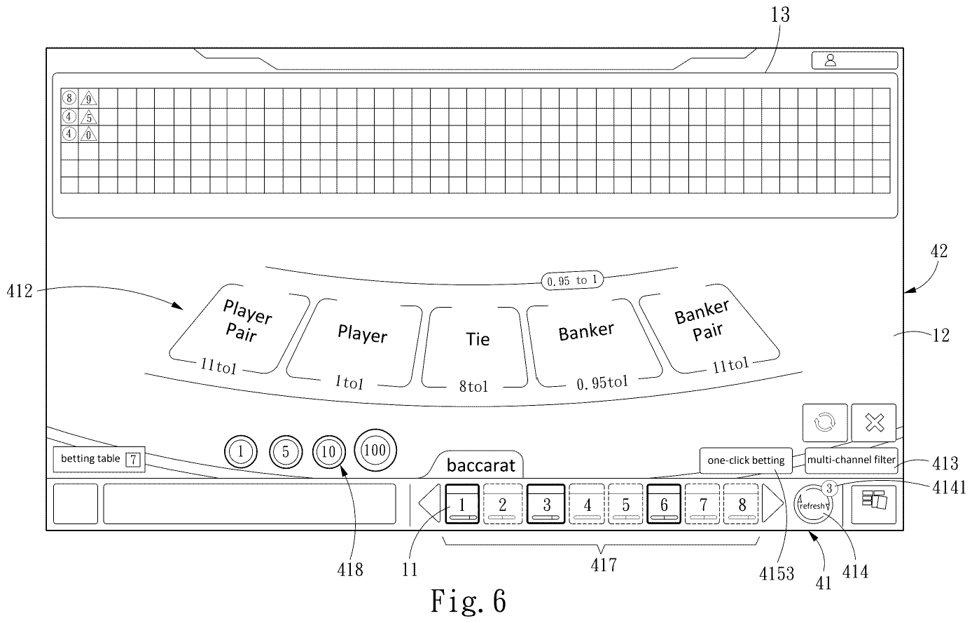

Referring to FIG. 2, FIG. 3C and FIG. 6 together, a second embodiment of the present invention is shown. Compared with the first embodiment, except for the at least one filtering selection button 416 (multi-channel filter 413) and the plurality of betting buttons 418, the operation interface 41 further comprises at least one symbol selection button 417. The at least one filtering selection button 416 corresponds to the at least one filtering rule, the at least one symbol selection button 417 corresponds to different identification symbols, and the plurality of betting buttons 418 are used to bet on the plurality of game results.

In the second embodiment, when the game processing unit 60 performs steps S1-S4, in step S2, after the player selects one of the at least one filtering rule through the at least one filtering selection button 416, the filter 30 is commanded to filter out the baccarat games conforming to the filtering rule. In an embodiment, the player first selects and clicks the multi-channel filter 413 (as shown in FIG. 6), and then the at least one filtering selection button 416 (as shown in FIG. 3C) will be displayed. Then the player can select and click any of the at least one filtering selection button 416.

In step S3, the display assembly 42 is commanded to display the identification symbol 11 of the baccarat games conforming to the filtering rule to the player, as shown in FIG. 6. In an embodiment, the identification symbol 11 is displayed as “1”, “2”, “3”, “4”, “5”, “6”, “7”, “8”; and the outline of the identification symbol 11 is faded (indicated by dotted lines) and lightened (indicated by bold frames) so as to distinguish whether the filtering rule is met. If the identification symbol 11 is indicated in a faded way (indicated by dotted lines, such as the identification symbol 11 of “2”, “4”, “5”, “7”, “8”), it means the filtering rule is not met. If the identification symbol 11 is indicated in a lightened way (indicated by bold frames, such as the identification symbol 11 of “1”, “3” “6”), it means the filtering rule is met. In another embodiment, it's rational to display only the identification symbols 11 conforming to the filtering rule. For example, only the identification symbols 11 of “1”, “3”, “6” are displayed. After the player selects a specific identification symbol 11 through the at least one symbol selection button 417, the display assembly 42 is commanded to display the game picture 12 and the historical game record 13 of a baccarat game corresponded, which can be varied according to betting and filtering results. For example, the display assembly 42 preferentially displays a baccarat game that has been betted, and the display assembly 42 preferentially displays a first baccarat game conforming to the filtering rule when the baccarat game has yet been betted.

In step S4, providing the player to bet on the baccarat game selected through the plurality of betting buttons 418, in an embodiment, the plurality of betting buttons 418 are chips with different denominations, and the player can select and click the chips first, and then select and click any one of five betting zones of the betting options 412 to complete betting.

Referring to FIG. 2 and FIG. 3A together, in one embodiment, the present invention further provides a game filtering method of the baccarat game system 10, wherein the game filtering method comprises the following steps performed by the game processing unit 60:
commanding the game result generating unit 20 to execute the plurality of baccarat games;
commanding the filter 30 to filter the historical game records 13 of the baccarat games according to the filtering rule selected from at least one filtering rule by the player through the operation interface 41, so as to filter out the baccarat games conforming to the filtering rule;
commanding the display assembly 42 to display the historical game record 13 of the baccarat games conforming to the filtering rule to the player, so that the player can bet on at least one baccarat game conforming to the filtering rule; and
commanding the payout processing unit 50 to pay out to the player according to a game result after the player bets through the operation interface 41 and a new game result of the baccarat game is generated.

To sum up, the advantages of the present invention at least include:
1. Through assistance of the filter, the game picture of the baccarat game conforming to the filtering rule can be displayed on the display assembly, so that the at least one player can directly select the baccarat game conforming to the filtering rule to bet, thereby improving the betting efficiency, eliminating the time of checking the historical game records one by one, and further increasing the actual playing time of the player. Hence, the turnover can be increased.
2. By executing the at least one betting rule through the one-click betting processing unit, the betting can be completed quickly; and the bet amount can be increased, thereby increasing the turnover.

What is claimed is:

1. A baccarat game system for filtering game, provided for at least one player to play, and the baccarat game system comprising:
a game result generating unit, executing a plurality of baccarat games, wherein each of the plurality of baccarat games independently executes and continuously generates one of a plurality of game results, each of the plurality of baccarat games includes an identification symbol and a game picture, and each of the plurality of baccarat games includes a historical game record constituted of the plurality of game results generated;
a filter, filtering out historical game records of the plurality of baccarat games according to a filtering rule selected from at least one filtering rule, so as to filter out baccarat games conforming to the filtering rule;
at least one player unit, comprising an operation interface and a display assembly, wherein the operation interface is operated by the at least one player for playing, and the display assembly provides game information to the at least one player;
a payout processing unit, paying out to the at least one player; and
a game processing unit, connecting to the game result generating unit, the filter, the at least one player unit and the payout processing unit, wherein the game processing unit performs the following steps:
commanding the game result generating unit to execute the plurality of baccarat games;
commanding the filter to filter out the baccarat games conforming to the filtering rule after the at least one player selecting the filtering rule from at least one filtering rule by the at least one player through the operation interface;
commanding the display assembly to display the historical game records of the baccarat games conforming to the filtering rule to the at least one player; and
commanding the payout processing unit to pay out to the at least one player according to the game result after the at least one player betting on a baccarat game selected through the operation interface and a new game result of the baccarat game is generated.

2. The baccarat game system according to claim 1, wherein the baccarat game system further comprises a one-click betting processing unit connected to the game processing unit, the one-click betting processing unit executes at least one betting rule, and wherein the operation interface comprises at least one one-click betting selection button corresponding to the at least one betting rule, and when the filter filters out the baccarat games conforming to the filtering rule, if the at least one player selects and clicks the at least one one-click betting selection button, the game processing unit controls the one-click betting processing unit directly execute the at least one betting rule corresponded, so as to bet on the baccarat games conforming to the filtering rule.

3. The baccarat game system according to claim 2, wherein the one-click betting processing unit generates a display program during betting, and the display program displays information of actual betting by the one-click betting processing unit on the display assembly.

4. The baccarat game system according to claim 2, wherein a bet amount of betting made by the one-click betting processing unit on the baccarat games conforming to the filtering rule is a certain value.

5. The baccarat game system according to claim 2, wherein a sum of bets made by the one-click betting processing unit on the baccarat games conforming to the filtering rule is a total bet amount, the total bet amount is a certain value, and a bet amount of the baccarat games conforming to the filtering rule is obtained by equally dividing the total bet amount.

6. The baccarat game system according to claim 5, wherein the bet amount of the baccarat games conforming to the filtering rule is allocated according to numbers of consecutive times conforming to the filtering rule.

7. The baccarat game system according to claim 1, wherein the at least one filtering rule is generated by self-setting.

8. The baccarat game system according to claim 7, wherein the at least one filtering rule is generated by setting of the at least one player.

9. The baccarat game system according to claim 1, wherein the baccarat game system is connected to a network server, the network server is connected to a plurality of remote operating machines and a plurality of mobile devices, and the plurality of remote operating machines and the plurality of mobile devices are respectively used as the at least one player unit for the at least one player using.

10. The baccarat game system according to claim 1, wherein the operation interface further comprises a filtering refresh button, and when the filtering refresh button is triggered, the filter re-filters out the baccarat games conforming to the filtering rule.

11. The baccarat game system according to claim 10, wherein the filtering refresh button automatically displays a latest filtering information.

12. The baccarat game system according to claim 1, wherein the operation interface is one of a mouse and a keyboard, and the display assembly is a computer screen.

13. The baccarat game system according to claim 1, wherein the operation interface and the display assembly are combined into a touch screen.

14. A baccarat game system for filtering game, provided for at least one player to play, and the baccarat game system comprising:
a game result generating unit, executing a plurality of baccarat games, wherein each of the plurality of baccarat games independently executes and continuously generates one of a plurality of game results, each of the plurality of baccarat games includes an identification symbol and a game picture, and each of the plurality of baccarat games includes a historical game record constituted of the plurality of game results generated;
a filter, filtering out historical game records of the plurality of baccarat games according to a filtering rule selected from at least one filtering rule, so as to filter out baccarat games conforming to the filtering rule;
at least one player unit, comprising an operation interface and a display assembly, wherein the operation interface is operated by the at least one player for playing, and the display assembly provides game information to the at least one player, and wherein the operation interface comprises at least one filtering selection button corresponding to the at least one filtering rule, at least one symbol selection button corresponding to different identification symbols and a plurality of betting buttons used to bet on the plurality of game results;
a payout processing unit, paying out to the at least one player; and
a game processing unit, connecting to the game result generating unit, the filter, the at least one player unit and the payout processing unit, and the game processing unit performs the following steps:
commanding the game result generating unit to execute the plurality of baccarat games;
commanding the filter to filter out the baccarat games conforming to the filtering rule after the at least one player selecting the filtering rule from the at least one filtering rule through the at least one filtering selection button;
commanding the display assembly to display the identification symbol of the baccarat games conforming to the filtering rule the at least one player, and after the at least one player selecting a specific identification symbol through the at least one symbol selection button, commanding the display assembly to display the game picture and the historical game record of a baccarat game corresponded; and
commanding the payout processing unit to pay out to the at least one player according to the game result after the at least one player bets on a baccarat game selected through the plurality of betting buttons and a new game result of the baccarat game is generated.

15. The baccarat game system according to claim 14, wherein the baccarat game system comprising a one-click betting processing unit connected to the game processing unit, the one-click betting processing unit executes at least one betting rule, and wherein the operation interface comprises at least one one-click betting selection button corresponding to the at least one betting rule, and when the filter filters out the baccarat games conforming to the filtering rule, if the at least one player selects and clicks the at least one one-click betting selection button, the game processing unit commands the one-click betting processing unit to directly execute the at least one betting rule corresponded, so as to bet on the baccarat games conforming to the filtering rule.

16. The baccarat game system according to claim 15, wherein the one-click betting processing unit generates a display program after betting, and the display program displays information of actual betting by the one-click betting processing unit on the display assembly.

17. The baccarat game system according to claim 15, wherein a bet amount of betting made by the one-click betting processing unit on the baccarat games conforming to the filtering rule is a certain value.

18. The baccarat game system according to claim 15, wherein a sum of bets made by the one-click betting processing unit on the baccarat games conforming to the filtering rule is a total bet amount, the total bet amount is a certain value, and a bet amount of the baccarat games conforming to the filtering rule is obtained by equally dividing the total bet amount.

19. The baccarat game system according to claim 18, wherein the bet amount of the baccarat games conforming to the filtering rule is allocated according to numbers of consecutive times conforming to the filtering rule.

20. The baccarat game system according to claim 14, wherein the at least one filtering rule is generated by self-setting.

21. The baccarat game system according to claim 20, wherein the at least one filtering rule is generated by setting of the at least one player.

22. The baccarat game system according to claim 14, wherein the baccarat game system is connected to a network server, the network server is connected to a plurality of remote operating machines and a plurality of mobile devices, and the plurality of remote operating machines and the plurality of mobile devices are respectively used as the at least one player unit for the at least one player using.

23. The baccarat game system according to claim 14, wherein the operation interface further comprises a filtering refresh button, and when the filtering refresh button is triggered, the filter re-filters out the baccarat games conforming to the filtering rule.

24. The baccarat game system according to claim 23, wherein the display assembly corresponding to the at least one player automatically displays a latest filtering information.

25. A game filtering method of a baccarat game system, wherein the baccarat game system is provided for at least one player to play, and wherein the baccarat game system comprises a game result generating unit, a filter, at least one player unit, a payout processing unit and a game processing unit, and wherein each player unit comprises an operation interface and a display assembly, the operation interface is operated by the at least one player for playing, and the display assembly provides game information to the at least one player, and the game filtering method comprising the following steps performed by the game processing unit:
commanding the game result generating unit to execute a plurality of baccarat games, wherein each of the plurality of baccarat games independently executes and continuously generates one of a plurality of game results, each of the plurality of baccarat games includes an identification symbol and a game picture, and each of the plurality of baccarat games includes a historical game record constituted of the plurality of game results generated;
commanding the filter to filter out historical game records of the plurality of baccarat games according a filtering rule selected from at least one filtering rule by the at least one player through the operation interface, so as to filter out the baccarat games conforming to the filtering rule;
commanding the display assembly to display the historical game record of the baccarat games conforming to the filtering rule to the at least one player, so that the at least one player can bet on the at least one of the baccarat games conforming to the filtering rule; and
commanding the payout processing unit to pay out to the at least one player according to a game result after the at least one player bets through the operation interface and a new game result of the baccarat game is generated.

26. The game filtering method according to claim 25, wherein the baccarat game system further comprises a one-click betting processing unit connected to the game processing unit, the one-click betting processing unit executes at least one betting rule, and wherein the operation interface comprises at least one one-click betting selection button corresponding to the at least one betting rule, and when the filter filters out the baccarat games conforming to the filtering rule, if the at least one player selects and clicks the at least one one-click betting selection button, the game processing unit commands the one-click betting processing unit to directly execute the at least one betting rule corresponded, so as to bet on the baccarat games conforming to the filtering rule.

27. The game filtering method according to claim 26, wherein the one-click betting processing unit generates a display program during betting, and the display program displays information of actual betting by the one-click betting processing unit on the display assembly.

28. The game filtering method according to claim 26, wherein a bet amount of betting made by the one-click betting processing unit on the baccarat games conforming to the filtering rule is a certain value.

29. The game filtering method according to claim 26, wherein a sum of bets made by the one-click betting processing unit on the baccarat games conforming to the filtering rules is a total bet amount, the total bet amount is a certain value, and a bet amount of the baccarat games conforming to the filtering rule is obtained by equally dividing the total bet amount.

30. The game filtering method according to claim 29, wherein the bet amount of the baccarat games conforming to the filtering rule is allocated according to numbers of consecutive times conforming to the filtering rule.

31. The game filtering method according to claim 25, wherein the at least one filtering rule is generated by self-setting.

32. The game filtering method according to claim 31, wherein the at least one filtering rule is generated by setting of the player.

33. The game filtering method according to claim 25, wherein the baccarat game system is connected to a network server, the network server is connected to a plurality of remote operating machines and a plurality of mobile devices, and the plurality of remote operating machines and the plurality of mobile devices are respectively used as the at least one player unit for the at least one player using.

34. The game filtering method according to claim 25, wherein the operation interface further comprises a filtering refresh button, and when the filtering refresh button is triggered, the filter re-filters out the baccarat games conforming to the filtering rule.

35. The game filtering method according to claim 34, wherein the display assembly automatically displays a latest filtering information to the player.
